(19) United States
(12) Patent Application Publication
(10) Pub. No.: US 2024/0053430 A1
(43) Pub. Date: Feb. 15, 2024

(54) POSITION ESTIMATION SYSTEM, POSITION ESTIMATION METHOD, WIRELESS DEVICE AND ANALYSIS DEVICE

(71) Applicant: NIPPON TELEGRAPH AND TELEPHONE CORPORATION, Tokyo (JP)

(72) Inventors: Shinya TAMAKI, Musashino-shi, Tokyo (JP); Ryota SHIINA, Musashino-shi, Tokyo (JP); Tetsuya SUZUKI, Musashino-shi, Tokyo (JP); Yasutaka KIMURA, Musashino-shi, Tokyo (JP); Tomohiro TANIGUCHI, Musashino-shi, Tokyo (JP); Sei KOU, Musashino-shi, Tokyo (JP); Tomoya HATANO, Musashino-shi, Tokyo (JP); Takashi YAMADA, Musashino-shi, Tokyo (JP)

(73) Assignee: NIPPON TELEGRAPH AND TELEPHONE CORPORATION, Tokyo (JP)

(21) Appl. No.: 18/271,520

(22) PCT Filed: Jan. 22, 2021
(86) PCT No.: PCT/JP2021/002280

§ 371 Date: Jul. 10, 2023

(51) Int. Cl. G01S 5/02; H04W 64/00; G01S 5/00

(52) U.S. Cl. CPC G01S 5/0289; H04W 64/00; G01S 5/0036

(57) ABSTRACT

An object of the present invention is to provide a position estimation system capable of grasping position information of a plurality of wireless devices without using an external device such as a fixed beacon or a GPS, a position estimation method, a wireless device, and an analysis device. A position estimation system according to the present invention includes a plurality of wireless devices 11 and an analysis device 12, wherein the wireless devices 11 are each configured to: send beacon signals; transfer the beacon signals between the wireless devices 11 in a range that the beacon signals reach; update flags indicating transfer histories of the beacon signals at the time of transfer; and discard beacon signals sent by own wireless devices upon reception thereof. Any one of the wireless devices 11 is configured to collect the beacon signals, and the analysis device 12 analyzes the flags of the respective beacon signals collected by the wireless device 11-0, to estimate positions of the plurality of wireless devices 11.

### TECHNICAL FIELD

The present disclosure relates to a technique for estimating the positions of a plurality of wireless devices.

### BACKGROUND ART

FIG. 1 is a diagram for explaining a technique for estimating the positions of a plurality of wireless devices 11 by using a fixed beacon 10 (see NPL 1, for example). By using the fixed beacon, the positions of the wireless devices can be estimated even in a place where radio waves such as GPS cannot reach.

### CITATION LIST

### Non Patent Literature

[NPL 1] “Location Fingerprinting With Bluetooth Low Energy Beacons,” IEEE Journal on Selected Areas in Communications, Vol. 33, No. 11, pp. 2418-2428 (November 2015)

### SUMMARY OF INVENTION

### Technical Problem

By using the fixed beacon as described above, the positions of the wireless devices can be estimated even in a place where radio waves of GPS cannot reach, but there are costs associated with the installation, management, and operation of the fixed beacon. In other words, the technique for estimating the positions of wireless devices by a fixed beacon has the problem of cost reduction.

In order to solve the above problem, an object of the present invention is to provide a position estimation system capable of grasping position information of a plurality of wireless devices without using an external device such as a fixed beacon or a GPS, a position estimation method, a wireless device, and an analysis device.

### Solution to Problem

In order to achieve the object described above, the position estimation system according to the present invention transmits beacon signals among a plurality of wireless devices and estimates the topology of the wireless devices from a transmission path of each beacon signal.

Specifically, the position estimation system according to the present invention is a position estimation system including a plurality of wireless devices and an analysis device, wherein the wireless devices are each configured to:
send beacon signals;
transfer the beacon signals between the wireless devices in a range that the beacon signals reach;
update flags indicating transfer histories of the beacon signals at the time of transfer; and
discard beacon signals sent by own wireless devices upon reception thereof,
any one of the wireless devices is configured to collect the beacon signals, and
the analysis device analyzes the flags of the respective beacon signals collected by the wireless devices, to estimate positions of the plurality of wireless devices.

A position estimation method according to the present invention is a position estimation method for estimating positions of a plurality of wireless devices, the method comprising the steps of:
sending beacon signals from the wireless devices respectively;
transfer the beacon signals between the wireless devices in a range that the beacon signals reach;
updating flags indicating transfer histories of the beacon signals at the time of transfer;
discard beacon signals sent by own wireless devices upon reception thereof,
collecting the beacon signals with one of the wireless devices; and
analyzing the flags of the respective collected beacon signals, to estimate positions of the wireless devices.

Further, a wireless device according to the present invention includes a plurality of wireless devices whose respective positions are estimated by an analysis device, wherein the wireless devices are each configured to:
send beacon signals;
transfer the beacon signals between the wireless devices in a range that the beacon signals reach;
update flags indicating transfer histories of the beacon signals at the time of transfer; and
discard beacon signals sent by own wireless devices upon reception thereof,
any one of the wireless devices collects the beacon signals and notifies the analysis device of information on the beacon signals.

Further, an analysis device according to the present invention is an analysis device for estimating positions of a plurality of wireless devices,
the wireless devices are each configured to:
send beacon signals;
transfer the beacon signals between the wireless devices in a range that the beacon signals reach;
update flags indicating transfer histories of the beacon signals at the time of transfer; and
discard beacon signals sent by own wireless devices upon reception thereof,
any one of the wireless devices is configured to collect the beacon signals, and
the analysis device analyzes the flags of the respective beacon signals collected by the wireless device, to estimate positions of the plurality of wireless devices.

In this position estimation system, the wireless devices themselves send beacon signals, and the analysis device estimates the positional relationship among the wireless devices (topology, and distance relationship based on radio wave strength) on the basis of the proximity relationship, radio wave strengths, and other relationships collected by a parent wireless device of a root. Thus, the present invention can provide a position estimation system capable of grasping position information of a plurality of wireless devices without using an external device such as a fixed beacon or a GPS, a position estimation method, a wireless device, and an analysis device.

If there are no transfer histories in the flags of the beacon signals received by the wireless devices, the analysis device designates the wireless devices that sent the beacon signals as “parents,” and if there are transfer histories in the flags of the beacon signals received by the wireless devices, the analysis device designates the wireless device of the smallest number of 2 or higher in the transfer order as “parent.” For example, this position estimation system has steps (stages) for beacon transmission, and information (flag, etc.) indicating the steps to be sequentially executed are included in the beacon signals. By collecting such information of the beacon signals, the analysis device sets a beacon signal source viewed from the wireless devices, which have received the beacon signals of the first step, as a “parent of root.” On the other hand, for the wireless devices that receive the beacon signals that are not the first step, the analysis device traces back to the source of the beacon signals of the smallest number of steps above step 2 and makes these wireless devices the “parents.”

The analysis device of the position estimation system according to the present invention preferably receives input of position information of at least one of the wireless devices whose location is clear, and corrects the positions of the plurality of wireless devices estimated by the position information. If the position of at least one of the plurality of wireless devices is known, the information thereof can be used to improve the topology estimation accuracy.

The above inventions can be combined as much as possible.

### Advantageous Effects of Invention

The present invention can provide a position estimation system capable of grasping position information of a plurality of wireless devices without using an external device such as a fixed beacon or a GPS, a position estimation method, a wireless device, and an analysis device.

### BRIEF DESCRIPTION OF DRAWINGS

FIG. 1 is a diagram for explaining a related position estimation system.

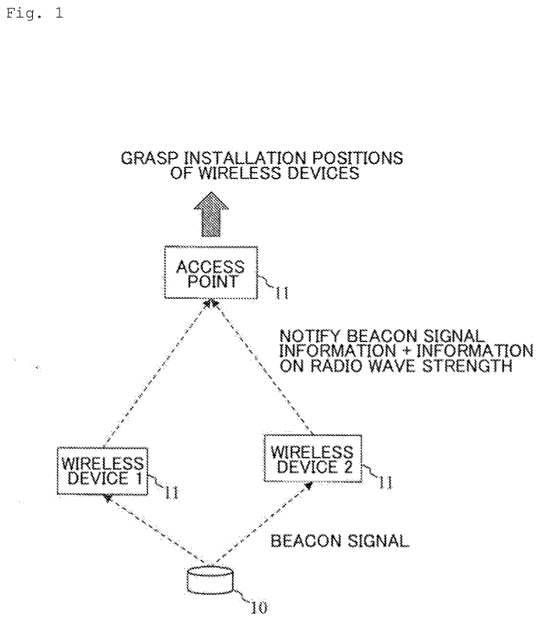

FIG. 2 is a diagram for explaining a position estimation system according to the present invention.

FIG. 3 is a diagram for explaining a position estimation method according to the present invention.

FIG. 4 is a diagram for explaining a wireless device according to the present invention.

FIG. 4 is a diagram for explaining a wireless device according to the present invention.

FIG. 6 is a diagram for explaining an analysis device according to the present invention.

FIG. 7 is a diagram for explaining the position estimation system according to the present invention.

FIG. 8 is a diagram for explaining an operation of the position estimation system according to the present invention.

FIG. 9 is a diagram for explaining an operation of the position estimation system according to the present invention.

FIG. 10 is a diagram for explaining an operation of the position estimation system according to the present invention.

FIG. 11 is a diagram for explaining an operation of the position estimation system according to the present invention.

FIG. 12 is a diagram for explaining an operation of the position estimation system according to the present invention.

FIG. 13 is a diagram for explaining an operation of the position estimation system according to the present invention.

FIG. 14 is a diagram for explaining an operation of the position estimation system according to the present invention.

FIG. 15 is a diagram for explaining an operation of the position estimation system according to the present invention.

FIG. 16 is a diagram for explaining the position estimation system according to the present invention.

FIG. 17 is a diagram for explaining the position estimation system according to the present invention.

FIG. 18 is a diagram for explaining the position estimation system according to the present invention.

FIG. 19 is a diagram for explaining an analysis method of the analysis device according to the present invention.

### DESCRIPTION OF EMBODIMENTS

Embodiments of the present invention will be described with reference to accompanying drawings. The embodiments described below are examples of the present invention, and the present invention is not limited to the following embodiments. In the present specification and the drawings, the components having the same reference numerals indicate the same components.

### SUMMARY OF INVENTION

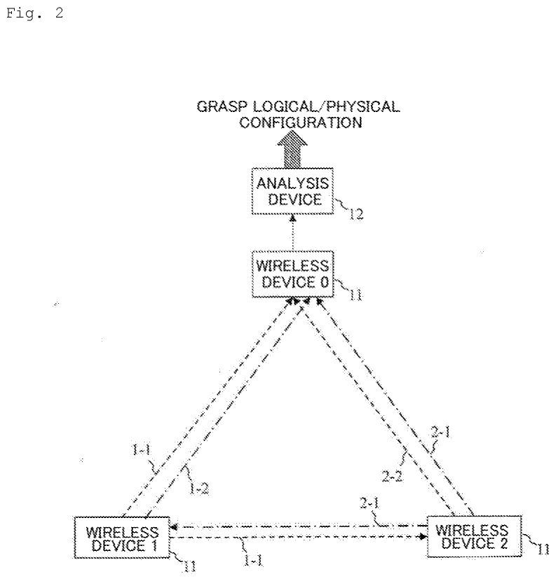

FIG. 2 is a diagram for explaining an outline of a position estimation system according to the present embodiment. This position estimation system is a position estimation system including a plurality of wireless devices 11 and an analysis device 12, wherein
the wireless devices 11 are each configured to:
send beacon signals;
transfer the beacon signals between the wireless devices 11 in a range that the beacon signals reach;
update flags indicating transfer histories of the beacon signals at the time of transfer; and
discard beacon signals sent by own wireless devices upon reception thereof,
any one of the wireless devices 11 (for example, a wireless device 11-0, which is an access point), collects the beacon signals, and
the analysis device 12 analyzes the flags of the beacon signals collected by the wireless device 11-0, to estimate the positions of the plurality of wireless devices 11.

Each wireless device 11 sends a beacon signal. The wireless device 11-0, which is an access point, may also send a beacon signal. The wireless device 11-0 is, for example, an access point, and wireless devices 11-1, 11-2 and the like are IoT (Internet of Things) terminals. Here, the notation of the beacon signal is referred to as “beacon signal (h-i).” The reference numeral “h” denotes the number of each wireless device 11, and the reference numeral “i” denotes the number of steps (hopes). For example, i=1 means a beacon signal sent from a wireless device and having no transfer history, and i=3 means a 3-step (hop count 2) beacon signal transferred by two wireless devices.

FIG. 2 illustrates the following.

The wireless device 11-1 sends a beacon signal 1-1, and the wireless device 11-0 and the wireless device 11-2 receive the beacon signal 1-1. Upon reception of the beacon signal 1-1, the wireless device 11-2 updates a flag indicating a transfer history (e.g., beacon information, radio wave strength, the number of hops, transfer route, and other information), and transfers the beacon signal as a beacon signal 2-2. The beacon signal 2-2 is received by the wireless device 11-0, the wireless device 11-1, and the other wireless devices 11 therearound. The wireless device 11-0 does not need to update the flag indicating the transfer history and transfer the beacon signal 1-1 upon reception of the beacon signal 1-1. Upon reception of the beacon signal 2-2, the wireless device 11-1 recognizes that said beacon signal is the one sent by said wireless device 11-1 from its flag, and discards the beacon signal 2-2.

The same applies to the wireless device 11-2.

The wireless device 11-2 sends a beacon signal 2-1, and the wireless device 11-0 and the wireless device 11-1 receive the beacon signal 2-1. Upon reception of the beacon signal 2-1, the wireless device 11-1 updates a flag indicating a transfer history. and transfers the beacon signal as a beacon signal 1-2. This beacon signal 1-2 is received by the wireless device 11-0, the wireless device 11-2, and the other wireless devices 11 therearound. The wireless device 11-0 does not need to update the flag indicating the transfer history and transfer the beacon signal 2-1 upon reception of the beacon signal 2-1. Upon reception of the beacon signal 1-2, the wireless device 11-2 recognizes that said beacon signal is the one sent by said wireless device 11-2 from its flag, and discards the beacon signal 1-2.

Updating and transferring the flag information of a beacon signal can be performed by using, for example, an extended region of a low-layer communication protocol.

Note that the configuration in which the wireless device 11-0 does not transfer the beacon signal received and the wireless device 11 that has sent a beacon signal and received it after transferred by another wireless device discards it is effective in preventing a beacon signal from increasing the amount of information as in broadcast streams.

The wireless device 11-0 notifies the analysis device 12 of the information of the flags from the received beacon signals. The analysis device 12 estimates topology between the wireless devices 11 on the basis of the collected information of the flags. Here, when the position information of at least one wireless device 11 whose location is clear is input, the analysis device 12 can correct the positions of the plurality of wireless devices 11 estimated by the position information. Examples of the information of the position whose location is clear is as follows.

(Example 1) Location information of the wireless device 11-0, which is an access point, is registered in a database 34 of the wireless device 11-0, and when the information of a flag is notified to the analysis device 12, the location information of the wireless device 11-0 is also notified to the analysis device 12.

(Example 2) From any mobile wireless terminal, location information (which room, etc.) is reported by a certain wireless device 11, and said wireless device 11 attaches the position information to the beacon signal and sends or transfers (or notifies the analysis device 12, if the wireless device is the wireless device 11-0) the beacon signal.

(Example 3) If there is a fixed beacon whose position is confirmed to be correct in the vicinity, this beacon signal is used.

### Embodiment 1

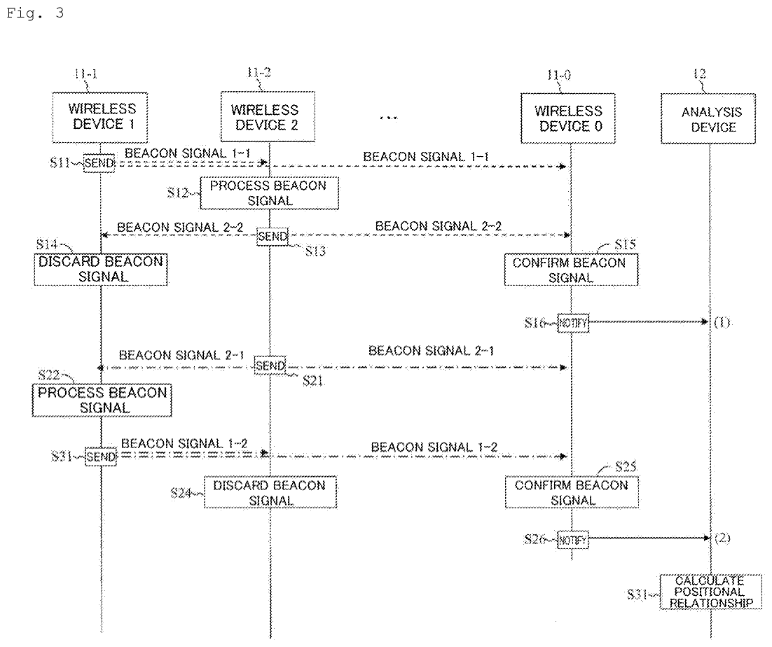

FIG. 3 is a diagram for explaining the position estimation method. The position estimation method is a position estimation method for estimating positions of a plurality of wireless devices 11, the method comprising the steps of: sending beacon signals from the wireless devices 11 respectively (steps S11, S21);
transfer the beacon signals between the wireless devices 11 in a range that the beacon signals reach;
updating flags indicating transfer histories of the beacon signals at the time of transfer (steps S12, S22);
discard beacon signals sent by own wireless devices upon reception thereof (steps S14, S24),
collecting the beacon signals with one of the wireless devices 11 (e.g., the wireless device 11-0, which is an access point) (steps S15, S25); and
analyzing the flags of the respective collected beacon signals, to estimate positions of the wireless devices 11 (step S31).

In step S11, the wireless device 11-1 sends a beacon signal 1-1. The beacon signal 1=1 is received by the surrounding wireless device 11-2 or wireless device 11-0. Note that there exists a wireless device which cannot receive the beacon signal 1-1 because the beacon signal 1-1 does not reach such wireless device; such a case will be described hereinafter. In step S12, the information of the beacon signal 1-1, received by the wireless device 11-2, is processed and prepared as the beacon signal 2-2. For example, the wireless device 11-2 updates the flag indicating the transfer history of the beacon signal 1-1 (e.g., counts up the number of hops) and sets the resultant flag as the beacon signal 2-2. Then, in step S13, the wireless device 11-2 transmits the beacon signal 2-2. The beacon signal 2=2 is received by the surrounding wireless device 11-1 or wireless device 11-0.

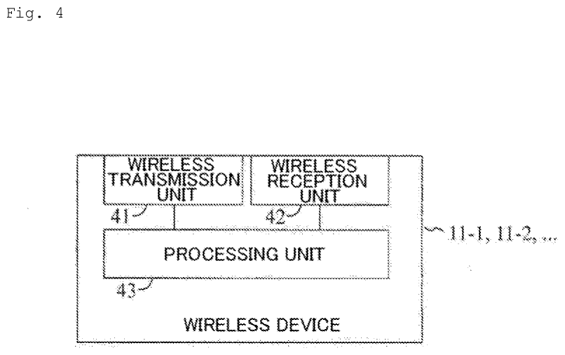

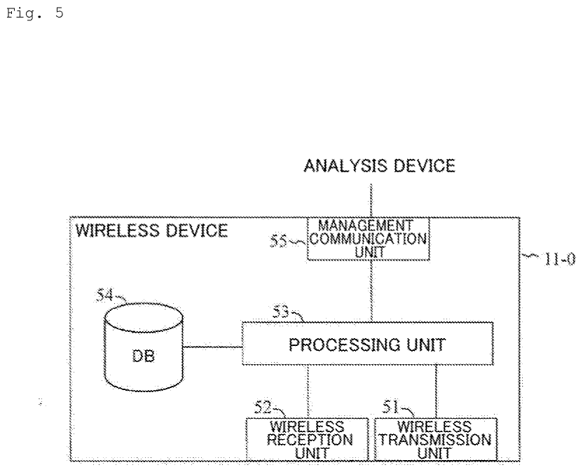

FIG. 4 is a block diagram for explaining the wireless devices (11-1, 11-2, . . . ). The wireless devices (11-1, 11-2, . . . ) include a wireless transmission unit 41, a wireless reception unit 42, and a processing unit 43. The wireless transmission unit 41 sends a beacon signal. The wireless reception unit 42 receives a beacon signal. The processing unit 43 processes information of a received beacon signal and prepares a beacon signal to be sent.

In step S14, the beacon signal 2-2 received by the wireless device 11-1 is confirmed. Here, the wireless device 11-1 discards the beacon 2-2 signal when the beacon 2-2 signal recognizes that the beacon signal 1-1 sent by the wireless device 11-1 is returned from an adjacent terminal. This is to prevent a beacon signal transferred like a broadcast stream from being looped.

In step S15, the beacon signal 1-1 and the beacon signal 2-2 received by the wireless device 11-0 are confirmed. The wireless device 11-0 compares information of the beacon signal 1-1 with information of the beacon signal 2-2, and grasps that the same signal as the beacon signal 1-1 (beacon signal 2-2) has reached via the wireless device 11-2 at the second hop. In step S16, the wireless device 11-0 notifies the analysis device 12 of information of each beacon signal (e.g., beacon information, radio wave strength, the number of hops, and nodes that have passed through). The analysis device 12 records the information as information (1).

FIG. 5 is a block diagram for explaining the wireless device 11-0. The wireless device 11-0 includes a wireless transmission unit 51, a wireless reception unit 52, a processing unit 53, a database 54, and a management communication unit 55. The wireless transmission unit 51 sends a beacon signal. The wireless reception unit 52 receives a beacon signal from each wireless device (11-1, 11-2, . . . ). The processing unit 53 compares received beacon signals and grasps information of each beacon signal. The management communication unit 55 notifies the analysis device 12 of the information of each beacon signal. The database 54 will be described hereinafter.

From step S21 to step S26, the same work as step S11 to step S16 is performed for the beacon signal 2-1 sent by the wireless device 11-2.

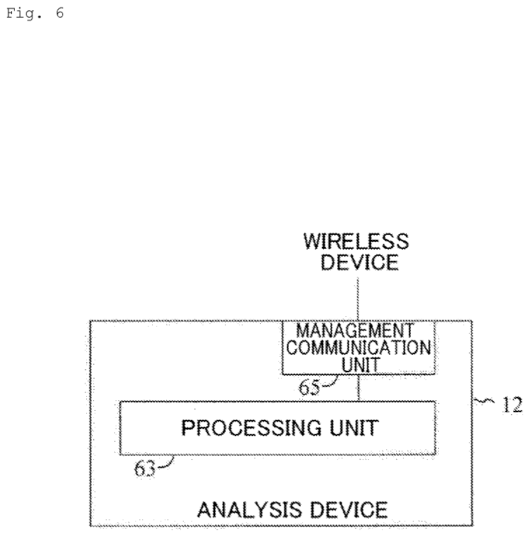

In step S31, the analysis device 12 analyzes information (1) and (2) of each notified beacon signal, and estimates a relative positional relationship between the wireless devices 11. FIG. 6 is a block diagram for explaining the analysis device 12. The analysis device 12 includes a processing unit 63 and a management communication unit 65. The management communication unit 65 receives information of each beacon signal from the wireless device 11-0. The processing unit 63 analyzes the information on each beacon signal and estimates a relative positional relationship between the wireless devices 11.

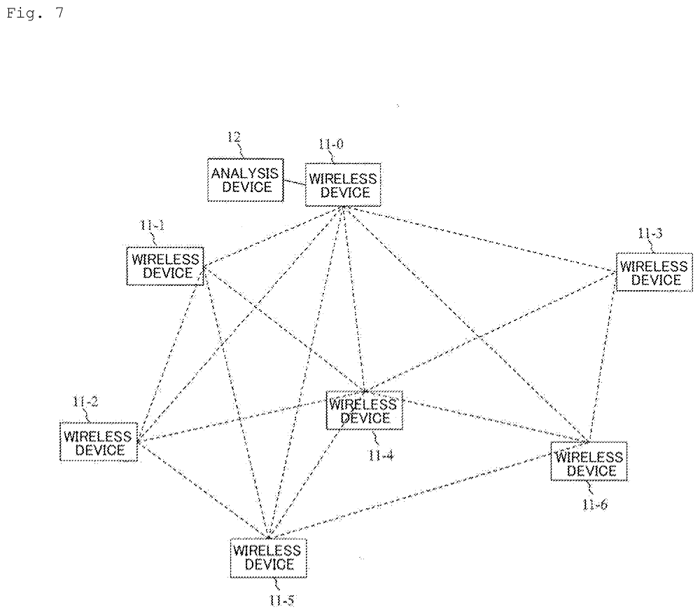

In the position estimation system according to the present embodiment, the respective devices work together as shown in FIG. 3, whereby, as shown in FIG. 7, although the system is not high, the positional relationship between wireless devices can be estimated with a certain level of accuracy without installing fixed beacons.

### Embodiment 2

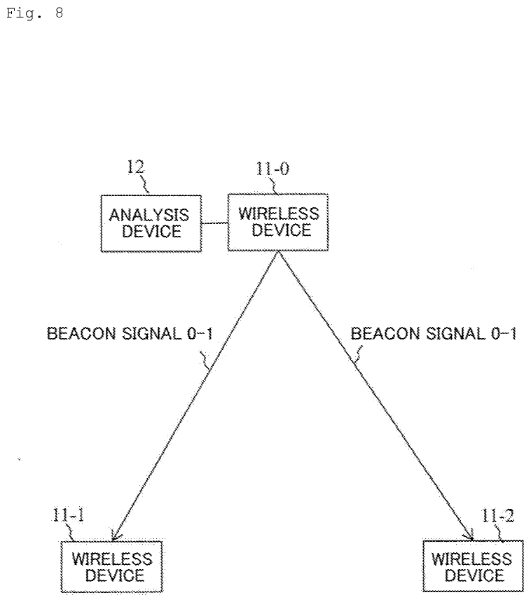

Referring to FIGS. 8 to 12, the detailed operation of a position estimation system according to the present embodiment will be described. In this example, the case where the wireless device 11-0, which is an access point, sends the beacon signal 0-1 of the first step is explained (the wireless device 11-0 is taken as “parent,” a beacon signal transmission source). As shown in FIG. 8, the wireless device 11-0 sends the beacon signal 0-1. The beacon signal 0-1 includes a flag indicating the beacon signal 0-1 is the first step (e.g., the number of hops 0). It is assumed that the beacon signal 0-1 reaches the wireless device 11-1 and the wireless device 11-2.

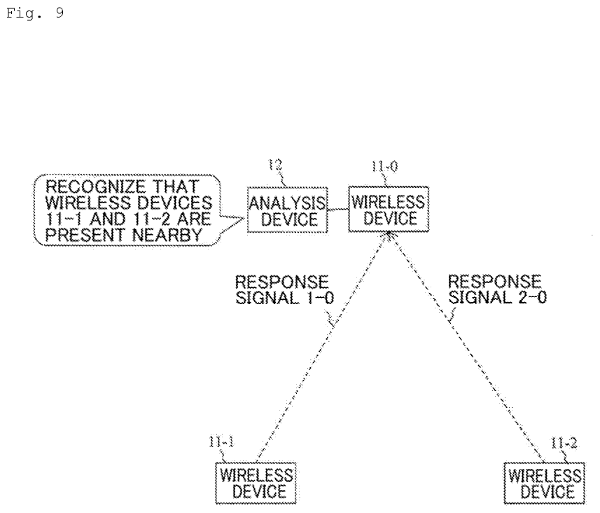

As shown in FIG. 9, the wireless device 11-1 and the wireless device 11-2, which have received the beacon signal 0-1, may send a response signal 1-0 and a response signal 2-0 to the wireless device 11-0 respectively. The wireless device 11-0 notifies the analysis device 12 that these response signals have been returned. The analysis device 12 recognizes that the wireless device 11-1 and the wireless device 11-2 are present in the neighborhood of the wireless device 11-0 (within a range where the beacon signal reaches). Here, if the information on the radio wave strength of the beacon signal is also included in the response signals, the distance from the wireless device 11-0 to the wireless device 11-1 and the distance from the wireless device 11-0 to the wireless device 11-2 can be recognized.

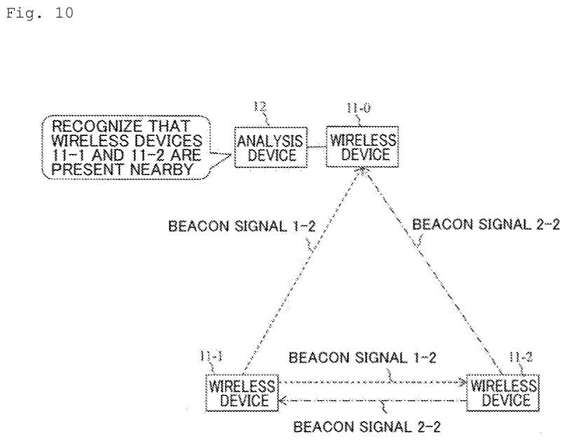

As shown in FIG. 10, the wireless device 11-1 and the wireless device 11-2 which have received the beacon signal 0-1 send the beacon signal 1-2 and the beacon signal 2-2. The beacon signal 1-1 and the beacon signal 2-2 include a flag indicating that the beacon signals are the second step (the number of hops 1). The beacon signal 1-2 and the beacon signal 2-2 may include information on the transmission source wireless device. The beacon signal 1-2 is received by the wireless device 11-0 and the wireless device 11-2. The beacon signal 2-2 is received by the wireless device 11-0 and the wireless device 11-1. By receiving the beacon signal 1-2 and the beacon signal 2-2, the wireless device 11-0 recognizes that the wireless device 11-1 and the wireless device 11-2 are present nearby. Furthermore, the wireless device 11-0 can recognize the distance between the wireless device 11-0 and the wireless device 11-1 and the distance between the wireless device 11-0 and the wireless device 11-2 from the information of the signal strengths of the beacon signal 1-2 and the beacon signal 2-2. The wireless device 11-0 notifies the analysis device 12 of these pieces of information.

Furthermore, the wireless device 11-1 receives the beacon signal 2-2 from the wireless device 11-2, and the wireless device 11-2 receives the beacon signal 1-2 from the wireless device 11-1.

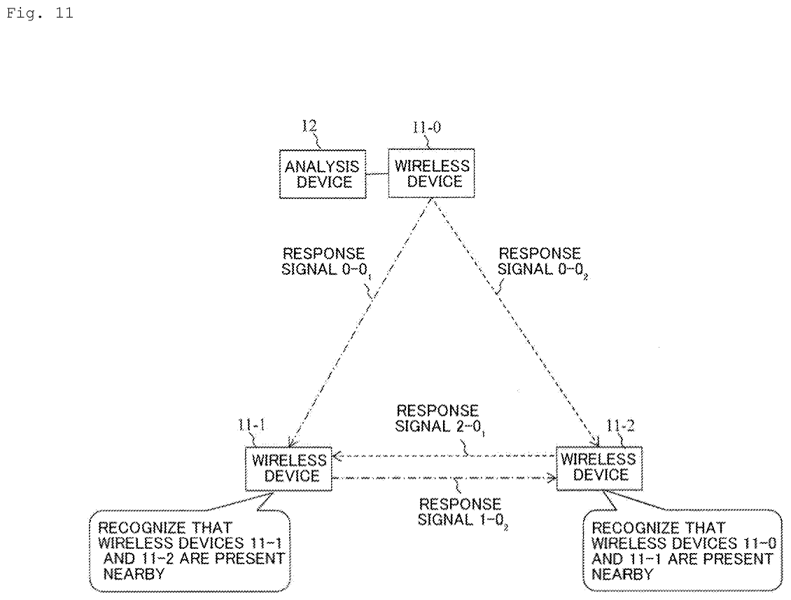

FIG. 11 is a diagram for explaining the operation of each wireless device which has received the beacon signals of the second step. The wireless device 11-0 sends a response signal 0-0₂ upon reception of the beacon signal 2-2, and sends a response signal 0-0₁ upon reception of the beacon signal 1-2.

Upon reception of the beacon signal 2-2, the wireless device 11-1 sends a response signal 1-0₂. Upon reception of the beacon signal 1-2, the wireless device 11-2 sends a response signal 2-0₁. By these response signals, the wireless device 11-1 recognizes that the wireless device 11-0 and the wireless device 11-2 are present nearby, and the wireless device 11-2 recognizes that the wireless device 11-0 and the wireless device 11-1 are present nearby. Since the wireless device 11-0 recognizes that the wireless device 11-1 and the wireless device 11-2 are present nearby at the time point shown in FIG. 9, the wireless device 11-0 may omit the transmission of the response signal 0-0₁ and the response signal 1-0₂.

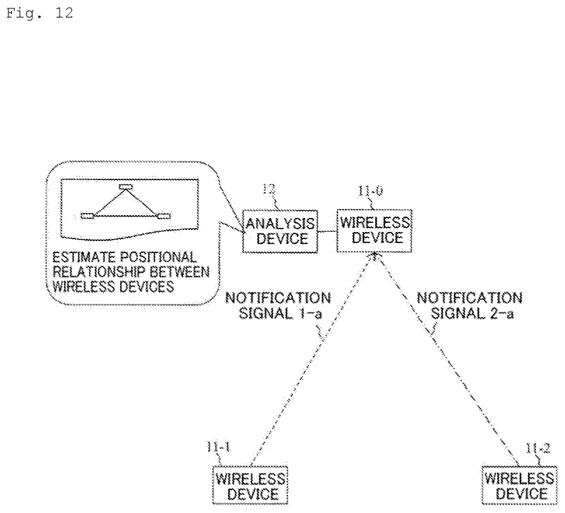

FIG. 12 is a diagram for explaining the operation of each wireless device which has received the response signal in response to the beacon signal of the second step. The wireless device 11-1 sends a notification signal 1-a notifying of the presence of the nearby wireless device 11-0 and the wireless device 11-2 to the wireless device 11-0. The wireless device 11-2 sends a notification signal 2-a notifying of the presence of the nearby wireless device 11-0 and the wireless device 11-1 to the wireless device 11-0. Since the wireless device 11-0 recognizes that the wireless device 11-1 and the wireless device 11-2 are present nearby at the time point shown in FIG. 9, the notification signals may not include the presence of the wireless device 11-0.

By receiving the notification signal 1-a, the wireless device 11-0 recognizes the presence of the wireless device 11-2 in the neighborhood of the wireless device 11-1 (within a range where beacon signals reach), and notifies the analysis device 12 of the presence. Also, by receiving the notification signal 2-a, the wireless device 11-0 recognizes the presence of the wireless device 11-1 in the neighborhood of the wireless device 11-2 (within a range where beacon signals reach), and notifies the analysis device 12 of the presence. Here, if the information on the radio wave strengths of the beacon signal 1-2 and the beacon signal 2-2 are included in the respective notification signals, the distance from the wireless device 11-1 to the wireless device 11-2 can be recognized.

The analysis device 12 estimates the positional relationship between the wireless device 11-0, the wireless device 11-1 and the wireless device 11-2 on the basis of the notification from the wireless device 11-0 (the wireless device present in the neighborhood of each wireless device and the distance between the wireless devices).

### Embodiment 3

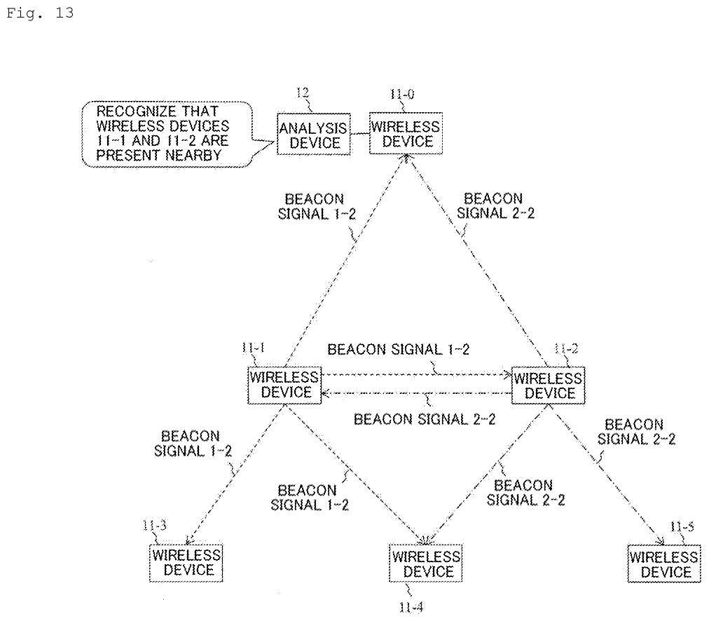

FIGS. 13 through 15 explain the detailed operation of a position estimation system according to the present embodiment. In this example, there are five wireless devices.

This example also describes the case where the wireless device 11-0, which is an access point, sends the beacon signal 0-1 of the first step, as shown in FIG. 8. However, in this example, it is assumed that the beacon signal 0-1 does not reach the wireless devices 11-3, 11-4, and 11-5.

FIG. 13 explains an operation performed after the wireless devices 11-1 and 11-2 send the response signals 1-0 and 2-0, respectively, as shown in FIG. 9 and the wireless device 11-0 receives them. The wireless device 11-1 and the wireless device 11-2 send the beacon signals 1-2 and 2-2 of the second step, respectively, as explained with reference to FIG. 10. It is assumed that the beacon signal 1-2 reaches the wireless devices 11-0, 11-2, 11-3, and 11-4. It is assumed that the beacon signal 2-2 reaches the wireless devices 11-0, 11-1, 11-4, and 11-5.

The method of estimating the positional relationship between the wireless devices 11-0, 11-1, and 11-2 by the analysis device 12 is as described in Embodiment 1.

On the other hand, the wireless devices 11-3, 11-4, and 11-5 receive the beacon signal of the second step without receiving the beacon signal of the first step. Therefore, the wireless devices 11-3, 11-4, and 11-5 recognize the sources of transmission of the beacon signals of the second step (i.e., the wireless devices 11-1 and 11-2) as “parents.” Therefore, the wireless devices 11-3, 11-4, and 11-5 perform the operations described in Embodiment 1 with the received beacon signals 1-2 and 2-2 as the beacon signal of the first step. That is, the wireless devices 11-3, 11-4, and 11-5 recognize the wireless devices existing in the neighborhood, by sending the beacon signals and the response signals to each other. Specifically, the wireless device 11-3 recognizes that the wireless devices 11-1 and 11-4 are present nearby, the wireless device 11-4 recognizes that the wireless devices 11-1, 11-2, 11-3, and 11-5 are present nearby, and the wireless device 11-5 recognizes that the wireless devices 11-2 and 11-4 are present nearby.

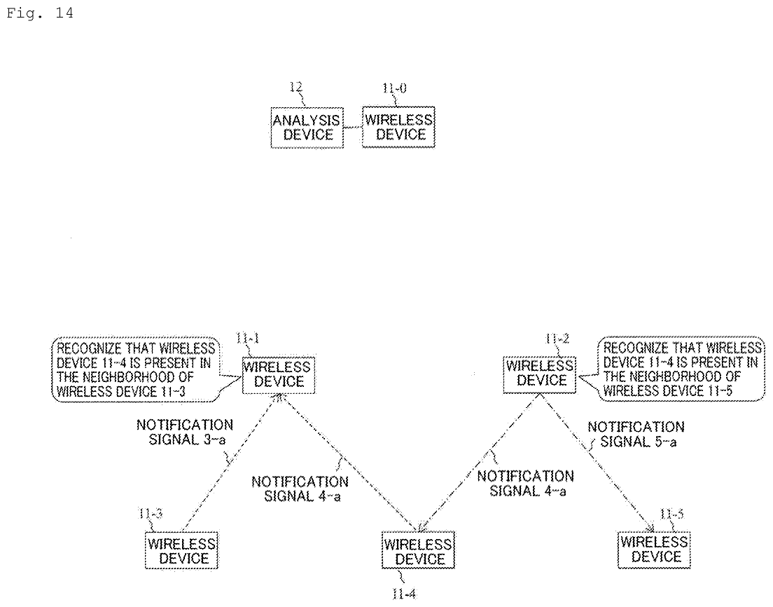

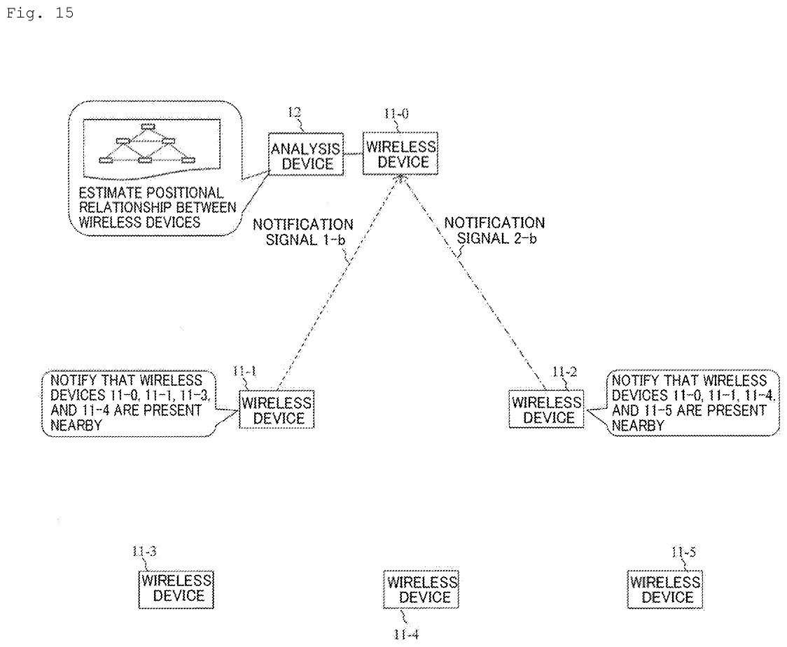

FIG. 14 is a diagram for explaining the operation of notifying wireless devices having the wireless devices 11-3, 11-4, and 11-5 as the parents, of information on a nearby wireless device. FIG. 15 is a diagram for explaining the operation performed after the wireless devices 11-1 and 11-2 receive notification signals from the wireless devices 11-3, 11-4, and 11-5.

By the notification signals, the wireless device 11-1 recognizes that the wireless devices 11-0, 11-2, 11-3, and 11-4 nearby, and notifies the wireless device 11-0 of the presence by means of a notification signal 1-b. Similarly, by the notification signals, the wireless device 11-2 recognizes that the wireless devices 11-0, 11-1, 11-4, and 11-5 nearby, and notifies the wireless device 11-0 of the presence by means of a notification signal 2-b. Since the wireless device 11-0 recognizes that the wireless device 11-1 and the wireless device 11-2 are present nearby at the time point shown in FIG. 9, the notification signals may not include the presence of the wireless device 11-0.

The analysis device 12 estimates the positional relationship between the wireless devices 11-0 to 11-5 on the basis of notification from the wireless device 11-0 (wireless device present in the neighborhood of each wireless device, the distance between wireless devices).

### Embodiment 4

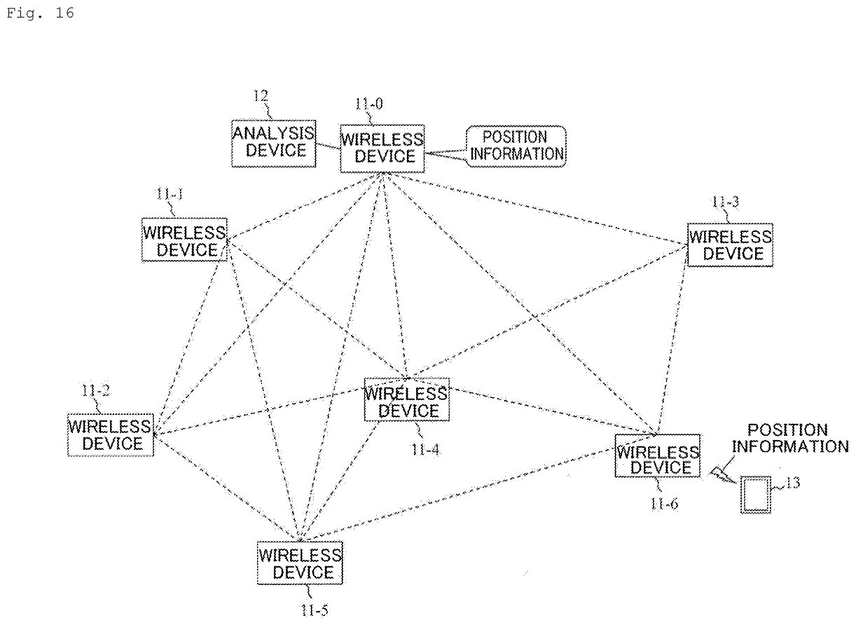

FIG. 16 is a diagram for explaining a positional estimation system according to the present embodiment. The position estimation system receives input of position information of at least one wireless device whose location is clear, and corrects the positions of a plurality of wireless devices estimated by the position information.

The relative positions of the wireless devices can be estimated by the method described in Embodiment 1 to Embodiment 3. However, the absolute positions of the wireless devices cannot be estimated. Therefore, in the position estimation system according to the present embodiment, the position information of at least one wireless device is given.

(Example 1) The position information of any one of the wireless devices is given to the analysis device 12.

(Example 2) The position information is given to the wireless device 11-0 whose position is fixed as in an access point, and the information is notified to the analysis device 12 at the time of position estimation. For example, the position information can be stored in the database 54 shown in FIG. 5.

(Example 3) The position information of the wireless device 11 is input from a terminal 13 that has approached said wireless device, and said position information is included in a notification signal for a “parent,” which is then notified to the analysis device 12.

The analysis device 12 translates the estimated positional relationship of the wireless devices based on the given position information, to improve the accuracy of the positions of the wireless devices.

### Embodiment 5

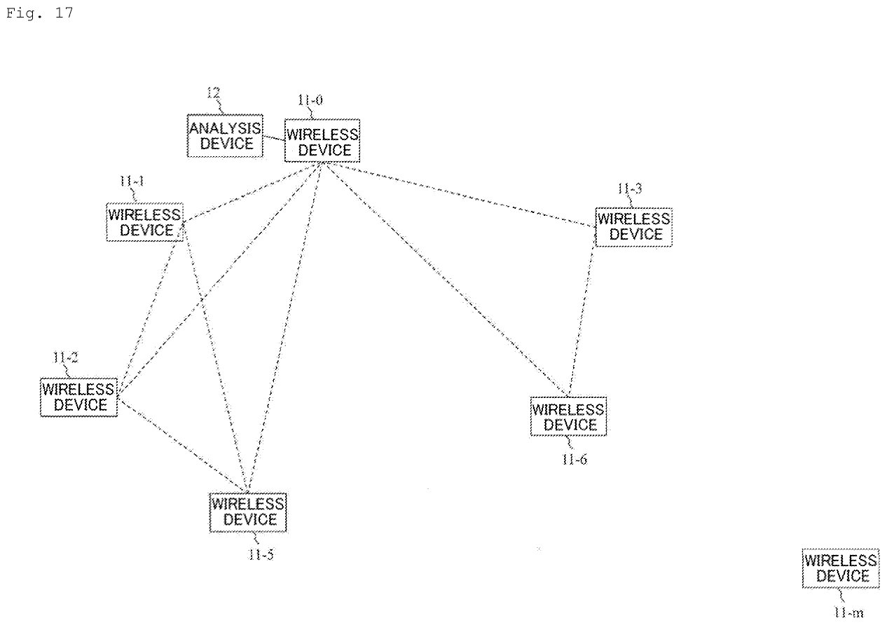

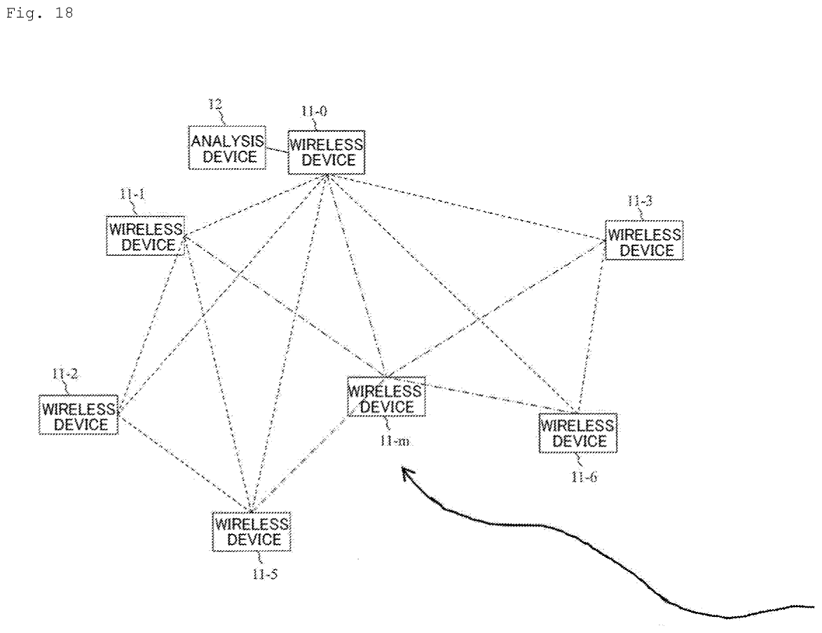

FIGS. 17 and 18 are diagrams for explaining a position estimation system according to the present embodiment. This position estimation system improves accuracy of estimating the position of a wireless device by using a movable wireless device.

The range where beacon signals reach is limited. Therefore, as shown in FIG. 17, when the arrangement of the wireless devices 11 is irregular and there are few or no other wireless devices 11 within the range where beacon signals reach, the accuracy of estimating the wireless device position by the analysis device 12 is reduced. Therefore, in the present embodiment, as shown in FIG. 18, a robot patrolling within the range of the position estimation system or a wireless device 11-m possessed by a worker is used to complement the space between the wireless devices 11. By moving the wireless device 11-m into the range of the position estimation system, the arrangement of the wireless devices 11 becomes denser and the beacon signal becomes easier to reach. Thus, the accuracy of estimating the wireless device position by the analysis device 12 is improved.

### Embodiment 6

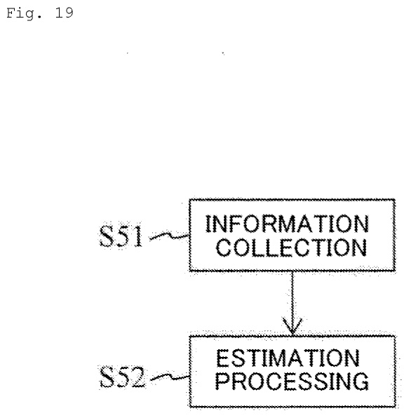

FIG. 19 is a flowchart for explaining the operation of the analysis device 12. The analysis device 12 performs an information collection step S51 and an estimation processing step S52.

In the information collection step S51, as described in Embodiment 1 to Embodiment 5, information on a wireless device present near each wireless device 11 (unique number, etc.) and on the intensity of a beacon signal exchanged between wireless devices are acquired from the wireless device 11-0.

In the estimation processing step S52, the position of a wireless device is estimated. The following method is used as the estimation method. Since the range where beacon signals reach is limited (e.g., within 20 m radius), the wireless device receiving a response signal is within the range from itself. By acquiring, from a plurality of wireless devices, information on a wireless device within the range, the positions of wireless devices can be estimated to some extent. Further, by using the positions of wireless devices whose positions are made clear in advance, the estimated position of each wireless device can be corrected.

### Other Embodiments

The analysis device 12 described in the foregoing embodiments can also be realized by a computer and a program, and the program can be recorded in a recording medium or provided through a network.

### Appendix

The position estimation device according to the present embodiment is described below.

### (Object)

The object is to provide a system for grasping a position of each wireless device, the system being capable of realizing
(1) eliminating the need to install a fixed beacon, use a GPS, and manage the fixed beacon and the GPS,
(2) preventing the explosion of the data distribution volume in the form of a broadcast storm, and
(3) preventing data from accumulating in an IoT terminal as much as possible.

### Means for Achieving the Object

This system has the following functions in order to achieve the objects (1) and (3) described above.

A wireless device serving as a root grasps the presence of a nearby wireless device by transmitting a first beacon signal and receiving a response signal corresponding to the first beacon signal.

A wireless device, which has received an n-th beacon signal but has not received an m-th beacon signal, n being a natural number and m being a natural number less than n, returns a response signal corresponding to the n-th beacon signal, sends an n+1-th beacon signal, and receives a response signal corresponding to the n+1-th beacon signal, to grasp the presence of a neighboring wireless device, and notify a wireless device that has transmitted the n-th beacon signal, of information on the neighboring wireless device and information notified from the neighboring wireless device, The wireless device serving as a root notifies the analysis device of the information on the neighboring wireless device and the information notified from the neighboring wireless device

The analysis device estimates a positional relationship between the respective wireless devices on the basis of the information notified from the wireless device serving as a root.

The present system has the following functions in order to achieve the object (2) described above.

A beacon signal includes information/flags such as the number of hops, the number of steps, and a parent-child relationship.

### REFERENCE SIGNS LIST

11, 11-0, 11-1, 11-2 Wireless device
11 Mobile wireless device
12 Analysis device
13 Terminal
41 Wireless transmission unit
42 Wireless reception unit
43 Processing unit
51 Wireless transmission unit
52 Wireless reception unit
53 Processing unit
54 Database
55 Management communication unit
63 Processing unit
65 Management communication unit

1. A position estimation system comprising a plurality of wireless devices and an analysis device, wherein
the wireless devices are each configured to:
send beacon signals;
transfer the beacon signals between the wireless devices in a range that the beacon signals reach;
update flags indicating transfer histories of the beacon signals at the time of transfer; and
discard beacon signals sent by own wireless devices upon reception thereof, any one of the wireless devices is configured to collect the beacon signals, and the analysis device analyzes the flags of the respective beacon signals collected by the wireless devices, to estimate positions of the plurality of wireless devices.

2. The position estimation system according to claim 1,
wherein
if there are no transfer histories in the flags of the beacon signals received by the wireless devices, the analysis device designates the wireless devices that send the beacon signals as “parents,” and
if there are transfer histories in the flags of the beacon signals received by the wireless devices, the analysis device designates the wireless device of the smallest number of 2 or higher in a transfer order as “parent.”

3. The position estimation system according to claim 1, wherein
the analysis device receives input of position information of at least one of the wireless devices whose location is clear, and corrects the positions of the plurality of wireless devices estimated by the position information.

4. A position estimation method for estimating positions of a plurality of wireless devices, the position estimation method comprising the steps of:
sending beacon signals from the respective wireless devices;
transfer the beacon signals between the wireless devices in a range that the beacon signals reach;
updating flags indicating transfer histories of the beacon signals at the time of transfer;
discard beacon signals sent by own wireless devices upon reception thereof, collecting the beacon signals with one of the wireless devices; and
analyzing the flags of the respective collected beacon signals, to estimate positions of the plurality of wireless devices.

5. (canceled)

6. An analysis device for estimating positions of a plurality of wireless devices, wherein
the wireless devices are each configured to:
send beacon signals;
transfer the beacon signals between the wireless devices in a range that the beacon signals reach;
update flags indicating transfer histories of the beacon signals at the time of transfer; and
discard beacon signals sent by own wireless devices upon reception thereof,
any one of the wireless devices is configured to collect the beacon signals, and
the flags of the beacon signals collected by the wireless devices are analyzed, to estimate the positions of the plurality of wireless devices.
